(19) United States
(12) Patent Application Publication
(10) Pub. No.: US 2025/0279412 A1
(43) Pub. Date: Sep. 4, 2025

(54) NEGATIVE ELECTRODE FOR ALL SOLID-STATE BATTERY AND ALL SOLID-STATE BATTERY INCLUDING SAME

(71) Applicant: SAMSUNG SDI CO, LTD., Yongin-si (KR)

(72) Inventors: SANGKYU LEE, Yongin-si (KR); Soomin HWANG, Yongin-si (KR); Myoungki MIN, Yongin-si (KR); Seokryul CHOI, Yongin-si (KR)

(21) Appl. No.: 18/932,784

(22) Filed: Oct. 31, 2024

(30) Foreign Application Priority Data
Mar. 4, 2024 (KR) 10-2024-0030870

(51) Int. Cl. H01M 4/36; H01M 4/02; H01M 4/38; H01M 4/583; H01M 10/0562

(52) U.S. Cl. CPC H01M 4/366; H01M 4/386; H01M 4/583; H01M 10/0562; H01M 2004/021; H01M 2004/027

(57) ABSTRACT

A negative electrode for an all solid-state battery includes a current collector, a first layer on the current collector, the first layer including a Si-carbon composite, and a second layer on the first layer, the second layer including a carbonaceous material and a metal, wherein a ratio of a capacity of the negative electrode/a capacity of a positive electrode is about 0.5 to about 2.

### CROSS-REFERENCE TO RELATED APPLICATION

This application claims priority to and the benefit of Korean Patent Application No. 10-2024-0030870, filed in the Korean Intellectual Property Office on Mar. 4, 2024, the entire contents of which are incorporated herein by reference.

### BACKGROUND

### 1. Field

Embodiments relate to a negative electrode for an all solid-state battery and an all solid-state battery including the same.

### 2. Description of the Related Art

Recently, there has been a rapid progress in electric devices using rechargeable batteries, e.g., mobile phones, laptop computers, and electric vehicles. In such a rechargeable battery, the development of an all solid-state battery, which uses lithium metal as the negative electrode, is desired.

The all solid-state battery refers to a battery in which all materials are solids, e.g., a battery using a solid electrolyte. The all solid-state battery is structurally strong because the electrolyte is solid, and thus, there is a reduced risk of fire or explosion caused by an electrolyte solution leakage due to external impact, or the like. The all solid-state battery may be formed in various shapes.

### SUMMARY

One or more embodiment provides a negative electrode for an all solid-state battery, including a current collector; a first layer on the current collector and including a Si-carbon composite; and a second layer on the first layer and including a carbonaceous material and a metal, wherein the all solid-state battery has a ratio of a capacity of the negative electrode/a capacity of a positive electrode (N/P ratio) of about 0.5 to about 2.

A ratio of a thickness of the first layer to a thickness of the second layer may be about 1.5:1 to about 6:1.

A ratio of a thickness of the first layer to a thickness of the second layer may be about 1.5:1 to about 4.5:1.

The first layer may have a thickness of about 5 μm to about 100 μm.

The second layer may have a thickness of about 1 μm to about 50 μm.

The Si-carbon composite may include silicon nano particles and amorphous carbon.

The Si-carbon composite may include a secondary particle, the secondary particle including aggregated silicon primary particles, and an amorphous carbon on surfaces of the primary particles and the secondary particle.

The Si-carbon composite may further include crystalline carbon.

The carbonaceous material may include crystalline carbon, amorphous carbon, or a combination thereof.

The carbonaceous material may include amorphous carbon.

The amorphous carbon may include carbon black, acetylene black, denka black, Ketjen black, furnace black, activated carbon, graphene, or a combination thereof.

The metal may include Ag, Au, Sn, Zn, Al, Mg, Ge, Cu, In, Ni, Bi, Pt, Pd, or a combination thereof.

The metal may include Ag.

Another embodiment provides an all solid-state battery including the negative electrode, the positive electrode, and a solid electrolyte between the negative electrode and the positive electrode.

### BRIEF DESCRIPTION OF THE DRAWINGS

Features will become apparent to those of skill in the art by describing in detail exemplary embodiments with reference to the attached drawings, in which:

FIG. 1 is a schematic diagram showing the negative electrode for an all solid-state battery according to one or more embodiment.

FIG. 2 is a schematic diagram showing an all solid-state battery according to one or more embodiments.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of elements and regions may be exaggerated for clarity of illustration. It will also be understood that when a layer or element is referred to as being “on” or “over” another element or substrate, it can be directly on or over the other element or substrate, or intervening elements may also be present. In addition, it will also be understood that when an element is referred to as being “between” two elements, it can be the only element between the two elements, or one or more intervening elements may also be present. Like reference numerals refer to like elements throughout.

Terms used in the specification are used to explain embodiments, but are not intended to be limiting. Expressions in the singular include expressions in plural unless the context clearly dictates otherwise.

The term “combination thereof may include a mixture, a laminate, a complex, a copolymer, an alloy, a blend, a reactant of constituents.

The terms “comprise”, “include” or “have” are intended to designate that the performed characteristics, numbers, steps, constituted elements, or a combination thereof is present, but it should be understood that the possibility of presence or addition of one or more other characteristics, numbers, steps, constituted element, or a combination thereof are not to be precluded in advance. In the specification, unless explicitly described to the contrary, the word “comprise” and variations such as “comprises” or “comprising” will be understood to imply the inclusion of stated elements but not the exclusion of any other element.

The terms “about” and “substantially” used throughout the present specification refer to the meaning of the mentioned with inherent preparation and material permissible errors when presented, and are used in the sense of being close to or near that value. They are used to help understand embodiments and to prevent unconscientious infringers from unfairly exploiting the disclosure where accurate or absolute values are mentioned.

In the specification, A and/or B and A or B are not exclusive terms, and indicate A, B, or both A and B.

In the present disclosure, “particle size” or “a particle diameter”, may be an average particle diameter. Unless otherwise defined in the specification, the average particle diameter may be defined as an average particle diameter (D50) indicating the diameter of particles having a cumulative volume of 50 volume % in the particle size distribution. The particle size may be measured by a method well known to those skilled in the art, e.g., by a particle size analyzer, or by a transmission electron microscopic image, a scanning electron microscopic image), or a field emission scanning electron microscopy (FE-SEM) . . . . In another embodiments, a dynamic light-scattering measurement device is used to perform a data analysis, and the number of particles is counted for each particle size range, and from this, the average particle diameter (D50) value may be easily obtained through a calculation, or a laser diffraction method. The laser diffraction may be obtained by distributing particles to be measured in a distribution solvent and introducing it to a commercially available laser diffraction particle measuring device (e.g., MT 3000 available from Microtrac, Inc.), irradiating ultrasonic waves of about 28 kHz at a power of 60 W, and calculating an average particle diameter (D50) in the 50% standard of particle distribution in the measuring device.

The term “thickness” may be measured through a photograph taken with an optical microscope such as a scanning electron microscope.

A negative electrode for an all solid-state battery according to one or more embodiments may include a current collector, a first layer on the current collector, and a second layer. The first layer may include a Si-carbon composite and the second layer may include a carbonaceous material and a metal.

The negative electrode according to one or more embodiments may be a negative electrode for an all solid-state battery having a ratio of a capacity of the negative electrode/a capacity of a positive electrode (N/P ratio) of about 0.5 to about 2. In one or more embodiments, the N/P ratio may be about 0.5 to about 1.5, e.g., about 0.5 to about 1.2 or about 0.5 to about 1. If the N/P ratio of the all solid-state battery including the negative electrode according to one or more embodiments is within the above range, an enhanced capacity retention may be exhibited.

In one or more embodiments, the capacity in the N/P ratio may be a theoretical capacity of the Si-carbon composite. For example, the N/P ratio may be obtained from the theoretical capacity of the first layer including the Si-carbon composite. The second layer including the carbonaceous material and the metal has a theoretical capacity close to infinite, and thus, it is impossible to define the N/P ratio. Thus, if the negative electrode only includes the second layer, the battery may not be defined by the N/P ratio.

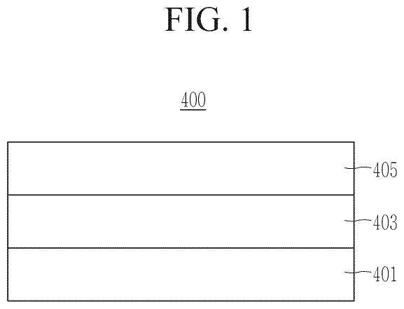

FIG. 1 schematically shows the structure of the negative electrode 400 according to one or more embodiments. Referring to FIG. 1, the negative electrode 400 may include a current collector 401, a first layer 403, and a second layer 405.

The all solid-state battery may form a lithium-containing layer, e.g., a lithium deposition layer, during charging and discharging, by transferring lithium ions released from a positive active material to the negative electrode and by depositing the lithium ions on a surface of the current collector. The second layer 405 may help such a lithium deposition, and the metal and the carbonaceous material included in the second layer 405 do not act as a negative active material which directly participates in the charge and discharge reaction. For example, the lithium-containing layer, e.g., the lithium deposition layer due to the deposition of lithium ions, may be formed and the lithium deposition may serve as a negative active material. Such a negative electrode may refer to a deposition-type negative electrode.

A conventional deposition-type negative electrode may potentially exhibit low safety due to the lithium deposition. The negative electrode 400, according to embodiments, may include the first layer 403 including the Si-carbon composite between the current collector 401 and the second layer 405, and the Si-carbon composite may react with lithium ions to deposit as a lithium alloy on the current collector 401, thereby improving safety of the negative electrode 400.

The first layer 403 may include the Si-carbon composite which may serve as an active material participating in the charge and discharge reaction, and thus, high capacity and high energy density may be exhibited. A first layer only including silicon (rather than a Si-carbon composite) may exhibit inferior safety to that including the Si-carbon composite, and a first layer only including a carbonaceous material (rather than a Si-carbon composite) may exhibit lower capacity than the first layer 403 including the Si-carbon composite.

In one or more embodiments, the ratio of the thickness of the first layer 403 and the thickness of the second layer 405 may be about 1.5:1 to about 6:1, e.g., about 1.5:1 to about 4.5:1 or about 1.5:1 to about 3:1. If the ratio of the thickness of the first layer 403 and the thickness of the second layer 405 satisfies the above range, the safety may be further improved and high-capacity and high energy density may be further enhanced.

In one or more embodiments, the thickness of the first layer 403 may be about 5 μm to about 100 μm, e.g., about 10 μm to about 60 μm or about 30 μm to about 40 μm. If the thickness of the first layer 403 is within the above range, higher capacity and higher energy density may be realized.

In one or more embodiments, the thickness of the second layer 405 may be about 1 μm to about 50 μm, e.g., about 5 μm to about 30 μm or about 10 μm to about 15 μm. If the thickness of the second layer 405 is within the above range, improved safety may be exhibited.

### [First Layer]

The Si-carbon composite included in the first layer 403 may include silicon particles and a carbonaceous material. For example, the silicon particles may be silicon nano particles, and the carbonaceous material may be an amorphous carbon or amorphous carbon and crystalline carbon. In another example, the silicon-carbon composite may include silicon nano particles and an amorphous carbon coating layer on surfaces of the silicon nano particles.

The silicon-carbon composite may include an aggregate, e.g., a secondary particle, where at least two silicon nano particles are aggregated, and an amorphous carbon coating layer is coated on a surface of the aggregate, e.g., the secondary particle.

The silicon nano particle may have a particle diameter of about 10 nm to about 1000 nm, e.g., about 10 nm to about 200 nm or about 20 nm to about 150 nm. If the particle diameter of the silicon nano particles is within the above range, an extreme volume expansion potentially caused during charge and discharge may be suppressed, and a breakage of the conductive path due to crushing of particles may be prevented.

The amorphous carbon may include a soft carbon, a hard carbon, a mesophase pitch carbonization product, calcined coke, or a combination thereof. The thickness of the amorphous carbon coating layer may be about 1 nm to about 2 μm, about 1 nm to about 500 nm, about 10 nm to about 300 nm, or about 20 nm to about 200 nm. For example, the thickness of the amorphous carbon coating layer may be measured by a SEM image or a TEM image for the cross-section of the silicon-carbon composite. In another example, the thickness of the amorphous carbon coating layer may be measured by any suitable measuring techniques. If the thickness of the amorphous carbon coating layer is within the above range, the volume expansion of silicon during charge and discharge may be well suppressed.

The silicon-carbon composite may further include crystalline carbon. If the silicon-carbon composite further includes crystalline carbon, it may include an aggregate where the silicon nano particles and the crystalline carbon are aggregated, and an amorphous carbon coating layer is coated on a surface of the aggregate. The crystalline carbon may be an unspecified-shaped, sheet-shaped, flake-shaped, spherical-shaped or fiber-shaped natural graphite or artificial graphite.

If the silicon-carbon composite includes the silicon nano particles and the amorphous carbon coating layer, based on a total 100 wt % of the silicon-carbon composite, an amount of the silicon nano particles may be about 30 wt % to about 70 wt %, e.g., about 40 wt % to about 65 wt %, and an amount of the amorphous carbon coating layer may be about 30 wt % to about 70 wt %, e.g., about 35 wt % to about 60 wt %. If the silicon-carbon composite further includes the crystalline carbon, based on a total 100 wt % of the silicon-carbon composite, an amount of the silicon nano particle may be about 20 wt % to about 70 wt %, e.g., about 25 wt % to about 65 wt %, an amount of the amorphous carbon may be about 25 wt % to about 70 wt %, e.g., about 25 wt % to about 60 wt %, and an amount of the crystalline carbon may be about 1 wt % to about 20 wt %, e.g., about 5 wt % to about 15 wt %.

The amorphous carbon may include a soft carbon, a hard carbon, a mesophase pitch carbonization product, calcined coke, or a combination thereof.

In one or more embodiments, the first layer 403 may further include a first binder. The first binder may be a non-aqueous binder, an aqueous binder, or a combination thereof.

The non-aqueous binder may be polyvinyl chloride, carboxylated polyvinylchloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be a styrene-butadiene rubber, a (meth)acrylated styrene-butadiene rubber, a (meth)acrylonitril-butadiene rubber, a (meth)acryl rubber, a butyl rubber, a fluorine rubber, polyethyleneoxide, polyvinyl pyrrolidone, polyepichlorohydrine, polyphosphazene, poly(meth)acrylonitrile, an ethylene propylene diene copolymer, polyvinylpyridine, chlorosulfonate polyethylene, latex, a polyester resin, a (meth)acryl resin, a phenol resin, an epoxy resin, polyvinyl alcohol, or a combination thereof.

The first binder may be a cellulose compound, and may be the cellulose compound together with the aqueous binder. The cellulose compound may be one or more of carboxymethyl cellulose, hydroxypropylmethyl cellulose, methyl cellulose, or alkali metal salts thereof. The alkali metal may be Na, K, or Li. The cellulose compound may serve as a binder and may serve as a thickener for imparting viscosity. The cellulose compound may be used in an appropriate amount within the amount of the binder, e.g., the amount of the cellulose compound may be, based on 100 parts by weight of the Si-carbon composite, about 0.1 parts by weight to about 3 parts by weight.

In the first layer 403, an amount of the Si-carbon composite may be, based on the total amount of the first layer 403, about 90 wt % to about 99 wt %, e.g., about 95 wt % to about 99 wt % or about 97 wt % to about 99 wt %. In the first layer 403, an amount of the first binder may be, based on the total weight of the first layer 403, about 1 wt % to 10 wt %, e.g., about 1 wt % to about 5 wt % or about 1 wt % to about 3 wt %.

The first layer 403 may further include a conductive material. The conductive material is included to provide electrode conductivity. Any electrically conductive material may be used as a conductive material unless it causes a chemical change. Examples of the conductive material may be a carbonaceous material such as natural graphite, artificial graphite, carbon black, acetylene black, ketjen black, a carbon fiber, a carbon nanofiber, carbon nanotubes, or the like; a metal-included material of a metal powder or a metal fiber including copper, nickel, aluminum, silver, or the like; a conductive polymer such as a polyphenylene derivative; or a mixture thereof.

If the first layer 403 further includes the conductive material, an amount of the conductive material may be, based on the total weight of the first layer 403, about 0.5 wt % to about 5 wt %, e.g., about 0.5 wt % to about 4 wt % or about 0.5 wt % to about 3 wt %. In case of further including the conductive material, the amount of the first binder in the first layer 403 may be appropriately adjusted depending on the amount of the conductive material.

The first layer 403 may further include an organic filler. The organic filler may be polyethyleneglycol diacrylate (PEGDA), polyethyleneglycol diglycidyl ether (PEGDE), polydimethylsiloxane (PDMS), or a combination thereof. If the first layer 403 further includes the organic filler, an amount of the organic filler may be appropriately adjusted, e.g., based on the total weight of the first layer 403, about 0.1 wt % to about 20 wt % or about 0.5 wt % to about 10 wt %.

### [Second Layer]

In the second layer 405, the carbonaceous material and the metal may be presented by being mixed together, or the metal may be presented by being supported on the carbonaceous material.

The carbonaceous material may be, e.g., crystalline carbon, amorphous carbon, or a combination thereof, or amorphous carbon. The crystalline carbon may be, e.g., natural graphite, artificial graphite, mesophase carbon microbeads, carbon nanotubes, graphene, or a combination thereof. The crystalline carbon may be unspecified-shaped, sheet-shaped, flake-shaped, spherical-shaped or fiber-shape. The amorphous carbon may be, e.g., carbon black, acetylene black, denka black, Ketjen black, furnace black, activated carbon, graphene, or a combination thereof. The carbon black may be Super P (available from Timcal, Ltd.). The amorphous carbon may include any suitable material which may be classified as amorphous carbon in the field.

In one or more embodiments, the carbonaceous material may include single particles or an aggregate that has a secondary particle form where primary particles are aggregated. If the carbonaceous material includes single particles, the size of the single particles may have an average particle diameter of about 100 nm or less, e.g., a nano size of about 10 nm to about 100 nm. If the carbonaceous material includes an aggregate, the particle diameter of the primary particle may be about 20 nm to about 100 nm and the particle diameter of the secondary particle may be about 1 μm to about 20 μm.

In one or more embodiments, a particle diameter of the primary particles may be about 20 nm to about 100 nm, about 20 nm to about 90 nm, about 20 nm to about 80 nm, or about 30 nm to about 70 nm. In one or more embodiments, a particle diameter of the secondary particle may be about 1 μm to about 20 μm, about 2 μm to about 15 μm, or about 3 μm to about 10 μm.

The shape of the primary particle may be spherical, oval, plate-shaped, or combinations thereof, and in some embodiments, the shape of the primary particle may be spherical, oval, or combinations thereof.

The metal in the second layer 405 may be Ag, Au, Sn, Zn, Al, Mg, Ge, Cu, In, Ni, Bi, Pt, Pd, or a combination thereof, and in another embodiments, the metal may be Ag. The inclusion of the metal in the second layer 405 may enhance the electrical conductivity.

The metal may be nano particles and the average size of the metal nano particles may be, e.g., about 5 nm to about 800 nm, about 5 nm to about 700 nm, about 5 nm to about 500 nm, or about 5 nm to about 300 nm. If the metal nanoparticles with nano size is used, the battery characteristics, e.g., cycle-life characteristics of the all solid-state battery, may be improved. If the metal particle size increases (e.g., to be within a micrometer range), the uniformity of the metal particles in the second layer 405 may decrease, the current density in a specific area may increase, and cycle life characteristics may deteriorate.

In one or more embodiments, an amount of the metal may be about 14 wt % to about 35 wt %, e.g., about 18 wt % to about 25 wt % or about 20 wt % to about 24 wt %, based on a total 100 wt % of the second layer 405. The amount of the carbonaceous material may be about 55 wt % to about 80 wt %, e.g., about 60 wt % to about 75 wt % or about 65 wt % to about 70 wt %, based on a total 100 wt % of the second layer 405.

The second layer 405 may further include a second binder. The second binder may be a non-aqueous binder.

The non-aqueous binder may be, e.g., polyvinyl chloride, carboxylated polyvinyl chloride, polyvinyl fluoride, polyethylene oxide, an ethylene propylene copolymer, polystyrene, polyvinyl pyrrolidone, polyurethane, polytetrafluoroethylene, polyvinylidene fluoride, polyethylene, polypropylene, polyamideimide, polyimide, polyacrylate, or a combination thereof.

An amount of the second binder may be about 1 wt % to about 15 wt %, based on a total 100 wt % of the second layer 405. For example, an amount of the second binder may be, based on the total 100 wt % of the second layer, about 1 wt % to about 14 wt %, about 1 wt % to about 12 wt %, about 1 wt % to about 10, about 2 wt % to about 8 wt %, or about 2 wt % to about 7 wt %.

If the second binder is included in the second layer 405 at the above weight range, the electrical resistance and the adherence may be improved, thereby enhancing the battery characteristics, e.g., cycle-life characteristics of the all solid-state battery.

In one or more embodiments, the second layer 405 may further include a solid electrolyte. Because the second layer 405 further includes the solid electrolyte, the interface adhesion to a solid electrolyte layer may be enhanced and shortcoming related to the volume expansion may be reduced.

The solid electrolyte may be an inorganic solid electrolyte such as a sulfide-included solid electrolyte, an oxide solid electrolyte, a halide-included solid electrolyte, and the like, or solid polymer electrolyte.

In one or more embodiments, the sulfide solid electrolyte may be Li₂S-P₂S₅, Li₂S—P₂S₅—LiX where X is an halogen element, e.g., I or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are each an integer of about 0 or more and about 12 or less, Z is Ge, Zn, or Ga), Li₂S—GeS₂, Li₂S—SiS₂—Li₃PO₄, Li₂S—SiS₂-LipMOq (where p and q are each an integer of about 0 or more and about 12 or less and M is P, Si, Ge, B, Al, Ga, or In), or LiₐM_{b}P_{c}S_{d}Aₑ (where a, b, c, d, and e are each an integer of about 0 or more and about 12 or less, M is Ge, Sn, Si, or a combination thereof, and A is F, Cl, Br, or I). The sulfide solid electrolyte may be, e.g., Li₂₋ₓPS₆₋ₓFₓ (0≤x≤2), Li₇₋ₓPS₆₋ₓClₓ (0≤x≤2), Li₂₋ₓPS₆₋ₓBrₓ (0≤x≤2) or Li₇₋ₓPS₆₋ₓIₓ (0≤x≤2). In some embodiment, the sulfide solid electrolyte may be Li₃PS₄, Li—P₃S₁₁, Li₇PS₆, Li₆PS₅Cl, Li₆PSCl, Li₆PS₅I, Li₆PS₅Br, Li_{5.8}PS_{4.8}Cl_{1.2}, Li_{6.2}PS_{5.2}Br_{0.8}, or the like.

In one or more embodiments, the sulfide solid electrolyte may be an argyrodite-type sulfide solid electrolyte. The argyrodite-type sulfide solid electrolyte may be, e.g., LiₐM_{b}P_{c}S_{d}Aₑ (where a, b, c, d, and e are each an integer of about 0 or more and about 12 or less, Mis Ge, Sn, Si, or a combination thereof, and A is F, Cl, Br, or I). In some embodiments, the argyrodite-type sulfide solid electrolyte may include Li₃PS₄, Li₂P₃S₁₁, Li₂PS₆, Li₆PS₅Cl, Li₆PS₅Br, Li_{5.8}PS_{4.8}Cl_{1.2}, Li_{6.2}PS_{5.2}Br_{0.8}, Li₆PS₅I, Li_{5.75}PS_{4.75}Cl_{1.25}, (Li_{5.69}Cu_{0.06})PS_{4.75}Cl_{1.25}, (Li_{5.72}Cu_{0.03})PS_{4.75}Cl_{1.25}, (Li_{5.69}Cu_{0.06})P(S_{4.70} (SO₄)_{0.05})Cl_{1.25}, (Li_{5.69}Cu_{0.06})P(S_{4.60} (SO₄)_{0.15})Cl_{1.25}, (Li_{5.72}Cu_{0.03})P(S_{4.725} (SO₄)_{0.025})Cl_{1.25}, (Li_{5.72}Na_{0.03})P(S_{4.725} (SO₄)_{0.025})Cl_{1.25}, Li_{5.75}P(S_{4.725} (SO₄)_{0.025})Cl_{1.25}, or a combination thereof.

The sulfide solid electrolyte may be amorphous, crystalline, or a combination thereof. The sulfide solid electrolyte may be prepared, e.g., by mixing Li₂S and P₂S₅ at a mole ratio of about 50:50 to about 90:10, e.g., about 50:50 to about 80:20. In the range of the mixing ratio, a sulfide solid electrolyte exhibiting excellent ionic conductivity may be prepared. As other components, SiS₂, GeS₂, B₂S₃, or the like may be further included therein, thereby further improving ionic conductivity.

The mixing procedure of the sulfur source for preparing the sulfide solid electrolyte may be performed by a mechanical milling or a solution method. The mechanical milling may be performed by adding starting raw material, a ball mill, or the like in a reactor and vigorously stirring to pulverize the starting raw material and to mix them together. The solution method may provide a solid electrolyte as a precipitate by mixing starting raw material in a solvent. If the heat treatment is performed after mixing, the crystal of the solid electrolyte may be further solidified and ionic conductivity may be further improved. For example, the sulfide solid electrolyte may be prepared by mixing sulfur raw materials and heat-treating them twice or more, which may provide a sulfide solid electrolyte with high ionic conductivity and rigidity.

The sulfide solid electrolyte may be a commercial solid electrolyte.

The oxide inorganic solid electrolyte may be, e.g., Li₁₊ₓTi₂₋ₓAl (PO₄)₃ (LTAP) (0≤x≤4), Li_{1+x+y}AlₓTi₂₋ₓSi_{y}P_{3-y}O₁₂ (0≤x≤2, 0≤y≤3), BaTiO₃, Pb(Zr,Ti)O₃(PZT), Pb₁₋ₓLaₓZr_{1-y}TiNO₃(PLZT) (0≤x<1, 0≤y<1), Pb (Mg₃Nb_{2/3})O₃-PbTiO₃(PMN-PT), HfO₂, SrTiO₃, SnO₂, CeO₂, Na₂O, MgO, NiO, CaO, BaO, ZnO, ZrO₂, Y₂O₃, Al_{z}O₃, TiO₂, SiO₂, lithium phosphate (Li₃PO₄), lithium titanium phosphate (LixTi. (PO₄) 3, 0<x<2, 0<y<3), Li_{1+x+y} (Al, Ga)ₓ(Ti, Ge)₂₋ₓSi_{y}P_{3-y}O₁₂ (0≤x≤1, 0≤y≤1), lithium lanthanum titanate (LixLayTiO_{3, 0}<x<2, 0<y<3), Li₂O, LiAlO₂, Li₂O—Al_{z}O₃—SiO₂—P₂O₅—TiO₂—GeO₂ ceramics, Garnet ceramics, Li₃₊ₓLa₃M₂O₁₂ (M=Te, Nb, or Zr, x is an integer of about 1 to about 10), or a mixture thereof.

The solid polymer electrolyte may be at least one selected from, e.g., polyethylene oxide, poly(diallyldimethylammonium) trifluoromethanesulfonylimide (poly(diallyldimethylammonium) TFSI), Cu₃N, Li₃N, LiPON, Li₃PO₄·Li₂S·SiS₂, Li₂S·GeS₂·Ga₂S₃, Li₂O·11Al₂O₃, Na₂O·11Al_{z}O₃, (Na,Li)₁₊ₓTi₂₋ₓAlₓ PO₄₃ (0.1≤x≤0.9), Li₁₊ₓHf₂₋ₓAlₓPO₄₃ (0.1≤x≤0.9), Na₅Zr₂Si₂PO₁₂, Li₃Zr₂Si₂PO₁₂, Na₅ZrP₃O₁₂, Na₅TiP₃O₁₂, Na₃Fe₂P₃O₁₂, Na₄NbP₃O₁₂, Na-Silicates, Li_{0.3}La_{0.5}TiO₃, Na₅MSi₄O₁₂ (M where M is a rare earth elements such as Nd, Gd, Dy, or the like) Li₅ZrP₃O₁₂, Li₅TiP₃O₁₂, Li₃FezP₃O₁₂, Li₄NbP₃O₁₂, Li₁₊ₓ (M,Al,Ga)ₓ (Ge_{1-y}T_{y})₂₋ₓ (PO₄)₃ (0≤x≤0.8, 0≤y≤1.0, M is Nd, Sm, Eu, Gd, Tb, Dy, Ho, Er, Tm, or Yb), Li_{1+x+y}QₓTi₂₋ₓSi_{y}P_{3-y}O₁₂ (0<x≤0.4, 0≤y≤0.6, Q is Al or Ga), Li₆BaLa₂ Ta₂O₁₂, Li₂La₃Zr₂O₁₂, Li₅La₃Nb₂O₁₂, Li₅La₃M₂O₁₂ (M is Nb, Ta) and Li₂₊ₓAₓLa₃₋ₓZr₂O₁₂ (0<x<3, A is Zn).

The halide solid electrolyte may include a Li element, a M element (where M is a metal except for Li), and a X element (where X is a halogen). The X may be, e.g., F, Cl, Br and I. In some embodiments, the halide solid electrolyte may include at least one of Br and Cl, as the X. The M may be, e.g., a metal element such as Sc, Y, B, Al, Ga, In, and the like.

The composition of the halide solid electrolyte may be represented by, e.g., Li₆₋₃ₐMₐBr_{b}Cl_{c} (where, M is a metal, except for Li, 0<a<2, 0≤b≤6, 0≤c≤6, b+c=6). The a may be about 0.75 or more, or about 1 or more, and the a may be about 1.5 or less. The b may be about 1 or more, or about 2 or more. The c may be about 3 or more, or about 4 or more. An example of the halide solid electrolyte may be Li₃ YBr₆, Li₃YCl₆ or Li₃ YBr₂Cl₄.

The second layer 405 may further include additives, e.g., a filler, a dispersant, an ion conductive material, or the like. As the filler, the dispersant, and the ionic conductive material included in the second layer, any suitable material for the all solid-state battery may be used.

### [Current Collector]

The current collector 401 may include, e.g., indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may have a foil shape or a sheet shape. A thickness of the current collector 401 may be about 1 μm to 20 μm, e.g., about 5 μm to about 15 μm or about 7 μm to about 10 μm.

The current collector 401 may include the metal as a substrate and may further include a thin film on the substrate. The thin membrane may include an element being capable of forming an alloy with lithium, e.g., gold, silver, zinc, tin, indium, silicon, aluminum, bismuth, or a combination thereof. If the current collector 401 further includes a thin membrane, the lithium-containing layer may be formed in a more flattened shaped, when the lithium is deposited during charging to form the lithium-containing layer, thereby further improving the cycle-life characteristics of the all solid-state battery.

A thickness of the thin membrane may be about 1 nm to about 800 nm, about 10 nm to about 700 nm, about 50 nm to about 600 nm, or about 100 nm to about 500 nm. If the thickness of the thin membrane is within the above range, the cycle-life characteristics may be further enhanced.

The negative electrode 400 according to one or more embodiments may further include a lithium-containing layer between the current collector 401 and the first layer 403 at the initial charge after the battery preparation. The lithium-containing layer may include a lithium alloy, e.g., a Li—Si alloy.

The thickness of the lithium-containing layer may be about 1 μm to about 1000 μm, about 1 μm to about 500 μm, about 1 μm to about 200 μm, about 1 μm to about 150 μm, about 1 μm to about 100 μm, or about 1 μm to about 50 μm. If the thickness of the lithium-containing layer is satisfied in the above range, it may effectively perform the role of a lithium reservoir and the cycle-life characteristics may be further enhanced.

The lithium-containing layer may further include a lithium metal. The inclusion of the lithium metal in the lithium-containing layer may be realized by releasing lithium ions from a positive active material, passing through the solid electrolyte and moving to the negative electrode, and absorbing all lithium ions to remain, and thus, it is participated and deposited on the negative current collector, after fabricating the battery.

The charging may be a formation process which may be performed at 0.05 C to 1 C at about 25° C. to about 50° C. once to three cycles. If lithium-containing layer is formed, lithium included in the lithium-containing layer is ionized during discharging to move to the positive direction, and thus, this lithium may be utilized as a negative active material.

In one or more embodiments, as the lithium-containing layer is positioned between the current collector 401 and the first layer 403, the first layer 403 may serve as a protecting layer for the lithium-containing layer, and thus, the deposition growth of lithium dendrite may be suppressed. This enables to inhibit capacity fading and short-circuit of the all solid-state battery and resultantly improve the cycle-life of the all solid-state battery.

### [Method of Preparing Negative Electrode]

A Si-carbon composite may be added to a first solvent to prepare a first layer composition, and a carbonaceous material and a metal are added to a second solvent to prepare a second layer composition.

A first binder may be further added to the first layer composition, or a conductive material, an organic filler, or a combination thereof may be further added. The first solvent may be N-methyl pyrrolidone, water, or the like.

A second binder may be further added to the second layer composition and a solid electrolyte may be added. To the second layer composition, an additive, e.g., a filler, a dispersant, an ion conductive material, or the like may be further added. The second solvent may be isobutyryl isobutyrate, xylene, toluene, benzene, hexane, or a combination thereof.

The Si-carbon composite, the carbonaceous material, the metal, the first binder, the second binder, the solid electrolyte, and the additive may be as described above. The amount of each component may be adjusted in order to obtain an amount of each component included in the negative electrode.

The first layer composition may be coated on the current collector 401 and dried to prepare the first layer 403, the second layer composition is coated on the first layer 403 and dried to prepare the second layer 405, thereby preparing the negative electrode 400. The drying may be, e.g., vacuum-drying.

### <all Solid-State Battery>

An all solid-state battery according to one or more embodiments may include the negative electrode 400, a positive electrode, and a solid electrolyte layer between the negative electrode and the positive electrode.

### <Solid Electrolyte Layer>

In one or more embodiments, the solid electrolyte layer may include a solid electrolyte. The solid electrolyte may be an inorganic solid electrolyte such as a sulfide solid electrolyte, an oxide solid electrolyte, a halide solid electrolyte, and the like, or solid polymer electrolyte.

In one or more embodiments, the solid electrolyte may be the sulfide solid electrolyte. The sulfide solid electrolyte may have excellent ionic conductivity and excellent cycle-life characteristics within the wider operation range, than other solid electrolytes such as an oxide solid electrolyte.

In one or more embodiments, an inorganic solid electrolyte, e.g., the sulfide solid electrolyte, the oxide solid electrolyte, the halide solid electrolyte, or the solid polymer electrolyte, is as described above. The solid electrolyte included in the solid electrolyte may be the same to or different from the solid electrolyte included in the second layer.

The solid electrolyte may have a particle shape. An average particle diameter D50 of the solid electrolyte may be about 5.0 μm or less, e.g., about 0.1 μm to about 5.0 μm, about 0.5 μm to about 5.0 μm, about 0.5 μm to about 4.0 μm, about 0.5 μm to about 3.0 μm, about 0.5 μm to about 2.0 μm, or about 0.5 μm to about 1.0 μm.

The solid electrolyte layer may further include a binder. The binder may be a styrene butadiene rubber, polytetrafluoroethylene, polyvinylidene fluoride, polyethylene, acrylate polymer or a combination thereof, or may be any other suitable material. The acrylate polymer may be butyl acrylate, polyacrylate, polymethacrylate, or a combination thereof.

In the solid electrolyte layer, an amount of the binder may be appropriately adjusted.

The solid electrolyte layer may be prepared by adding a solid electrolyte to a binder solution, coating it on a substrate film, and drying it. The binder solution may include isobutylyl isobutylate, xylene, toluene, benzene, hexane, or a combination thereof, as a solvent. A thickness of the solid electrolyte layer may be, e.g., about 10 μm to about 150 μm.

The solid electrolyte layer may further include an alkali metal salt, and/or an ionic liquid, and/or a conductive polymer.

The alkali metal salt may be, e.g., a lithium salt. In the solid electrolyte layer, an amount of the lithium salt may be about 1 M or more, e.g., about 1 M to about 4 M. In this case, the lithium salt may improve the lithium ion mobility of the solid electrolyte layer, thereby improving ionic conductivity.

The lithium salt may be, e.g., LiSCN, LiN(CN)₂, Li(CF₃SO₂)₃C, LiC₄F₉SO₃, LiN(SO₂CF₂CF₃)₂, LiCl, LiF, LiBr, LiI, LiB(C₂O₄)₂, LiBF₄, LiBF₃C₂F₅, lithium bis(oxalato) borate (LiBOB), lithium oxalyldifluoroborate (LIODFB), lithium difluoro (oxalato) borate (LiDFOB), lithium bis(trifluoro methanesulfonyl)imide (LiTFSI, LiN(SO₂CF₃)₂), lithium bis(fluorosulfonyl)imide (LiFSI), LiN(SO₂F)₂), LiCF₃SO₃, LiAsF₆, LiSbF₆, LiClO₄, or a mixture thereof.

The lithium salt may be an imide lithium salt, e.g., lithium bis(trifluoro methanesulfonyl)imide (LiTFSI, LiN(SO₂CF₃)₂), lithium bis(fluorosulfonyl)imide (LiFSI, or LiN(SO₂F)₂). The lithium salt may suitably maintain the chemical reactivity with the ionic liquid, and thus, the ionic conductivity may be maintained or improved.

The ionic liquid may have a melting point of a room temperature or less which may be a liquid state at a room temperature and salts consisting of only ion, or a room-temperature molten salt.

The ionic liquid may be a compound including a) at least one cation selected from a) ammonium, pyrroleridinium, pyridinium, pyrrimidinuim, imidazolium, piperidinum, pyrazolium, oxazolium, pyridazium, phosphonium, sulfonium, triazolium, or mixture thereof, and b) at least one anion selected from BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, BF₄⁻, SO₄⁻, CF₃SO₃⁻, F(SO₂)₂N⁻, (C₂F₅SO₂)₂N⁻, (C₂F₅SO₂)(CF₃SO₂)N⁻, or (CF₃SO₂)₂N⁻.

The ionic liquid may be, e.g., at least one selected from N-methyl-N-propylpyrrolidinium bis(trifluoromethanesulfonyl)imide N-butyl-N-methylpyrroliridinium bis(3-trifluoromethylsulfonyl)imide, 1-butyl-3-methylimidazolium bis(trifluoromethylsulfonyl)amide, 1-ethyl-3-methylimidazolium, or bis(trifluoromethylsulfonyl)amide.

In the solid electrolyte layer, the weight ratio of the solid electrolyte and the ionic liquid may be about 0.1:99.9 to about 90:10, e.g., about 10:90 to about 90:10, about 20:80 to about 90:10, about 30:70 to about 90:10, about 40:60 to about 90:10, or about 50:50 to about 90:10. The solid electrolyte layer within the range may have an improved electrochemical contact area to the electrode, and thus, the ionic conductivity may be maintained or improved. This may improve the energy density, discharge capacity, rate capability, and the like of the all solid-state battery.

### <Positive Electrode >

The positive electrode may include a positive current collector and a positive active material layer on the positive current collector.

The positive active material layer may include a positive active material. The positive active material may include compounds that reversibly intercalate and deintercalate lithium ions. For example, it may include one or more composite oxides of a metal selected from cobalt, manganese, nickel, and a combination thereof, and lithium.

The composite oxide may be a lithium transition metal composite oxide, and specific examples thereof may include lithium nickel oxide, lithium cobalt oxide, lithium manganese oxide, lithium iron phosphate compound, cobalt-free nickel-manganese oxide, or a combination thereof.

For example, the following compounds represented by any one of the following chemical formulas may be used: LiₐA_{1-b}X_{b}O_{2-c}Dₑ (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0≤a≤2); LiₐNi_{1-b-c}Mn_{b}X_{c}O_{2-α}D_{α} (0.90≤a≤1.8, 0≤b≤0.5, 0≤c≤0.5, 0≤α≤2); LiₐNi_{b}Co_{c}L_{d}¹GₑO₂ (0.90≤a≤1.8, 0<b>0.9, 0<<<0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the above chemical formulas, A is Ni, Co, Mn, or a combination thereof; X is Al, Ni, Co, Mn, Cr, Fe, Mg, Sr, V, a rare earth element or a combination thereof; D is O, F, S, P, or a combination thereof; G is Al, Cr, Mn, Fe, Mg, La, Ce, Sr, V, or a combination thereof; and L¹ is Mn, Al, or a combination thereof.

For example, the positive electrode active material may be a high nickel positive electrode active material having a nickel amount of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel positive electrode active material may realize high capacity and may be applied to a high-capacity, high-density rechargeable lithium battery.

According to some embodiments, the positive active material may be a three-component lithium transition metal oxide such as LiNiₓCo_{y}Al_{z}O₂ (NCA), LiNiₓCo_{y}Mn₂O₂ (NCM) (wherein, 0<x<1, 0<y<1, 0<z<1, x+y+z=1), etc.

The compounds may have a coating layer on the surface, or may be mixed with another compound having a coating layer. The coating layer may include at least one coating element compound selected from an oxide of a coating element, a hydroxide of a coating element, an oxyhydroxide of a coating element, an oxycarbonate of a coating element, and a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or mixture thereof. The coating layer may be provided by a method having no (or substantially no) adverse influence on properties of a positive active material by using these elements in the compound. For example, the method may include any suitable coating method such as spray coating, dipping, and/or the like.

In some embodiments, the coating layer may be any coating materials which are known as a coating layer for the positive active material of the all solid battery, e.g., Li₂O—ZrO₂ (LZO) or the like. For example, it may be a buffer layer which serves to reduce an interface resistance of the positive electrode active material and the solid electrolyte. For example, the buffer layer may include lithium-metal-oxide and this metal may be one or more elements selected from Al, B, Ca, Ce, Cr, Fe, Mg, Mo, Nb, Si, Sn, Sr, Ta, V, W, or Zr. The example of the buffer layer may be Li₂O—ZrO₂ (LZO), LiNbO₂, or the like.

If the positive electrode active material includes three-components including nickel, cobalt, and manganese, or nickel, cobalt, and aluminum, the capacity density of the all solid-state battery may be further improved, and the metal elution from the positive electrode active material at a charged state may be further reduced. This may further improve long reliability and cycle characteristics of the all solid-state battery at a charged state.

The average particle diameter of the positive electrode active material may be about 1 μm to 25 μm, e.g., 3 μm to 25 μm, 1 μm to 20 μm, 1 μm to 18 μm, 3 μm to 15 μm, or 5 μm to 15 μm. For example, the positive electrode active material may include small particles with an average particle diameter D50 of about 1 μm to about 9 μm and large particles with an average particle diameter D50 of about 10 μm to about 25 μm. The positive electrode active material with the above particle diameter range may be harmoniously mixed with other components in the positive electrode active material layer and may achieve high capacity and high energy density.

The positive active material may include secondary particles where a plurality of primary particles is aggregated, or may be a monocrystalline (single crystal). The shape of the positive electrode active material may be a spherical shape, a shape close to spherical, or a particle shape such as a polyhedron, an unspecified shape, or the like.

In the positive active material layer, an amount of the positive electrode active material may be in any suitable range which may be applied to a positive electrode layer of an all solid-state secondary battery. For example, based on a total 100 wt % of the positive electrode active material layer, the positive electrode active material may be included at about 55 wt % to about 99.5 wt %, e.g., about 65 wt % to about 95 wt % or about 75 wt % to about 91 wt %.

The positive electrode active material layer may further include a binder and/or a conductive material.

The binder may be polyvinyl alcohol, carboxymethyl cellulose, hydroxypropyl cellulose, diacetyl cellulose, polyvinylchloride, carboxylated polyvinylchloride, polyvinyl fluoride, polyethylene oxide, polyvinylpyrrolidone, polyurethane, polytetrafluoroethylene, polyvinylidene fluoride, polyvinylidene fluoride-hexafluoropropylene, polyethylene, polypropylene, a styrene-butadiene rubber, an acrylated styrene-butadiene rubber, an epoxy resin, nylon, or the like, but is not limited thereto.

The binder may be included in an amount of about 0.1 wt % to about 5 wt %, e.g., about 0.1 wt % to about 3 wt %, based on a total 100 wt % of the positive electrode active material layer. In the above range, the adhesion ability may be sufficiently secured without deteriorating the battery performance.

The conductive material is included to provide electrode conductivity. Any electrically conductive material may be used as a conductive material unless it causes a chemical change. Examples of the conductive material may include a carbonaceous material such as natural graphite, artificial graphite, carbon black, acetylene black, ketjen black, carbon fiber, carbon nanofiber, carbon nanotube and the like; a metal-included material of a metal powder or a metal fiber including; copper, nickel, aluminum, silver, and the like; a conductive polymer such as polyphenylene derivatives; or mixtures thereof.

The conductive material may be included in an amount of about 0.1 wt % to about 5 wt %, e.g., about 0.1 wt % to about 3 wt %, based on a total 100 wt % of the positive active material layer. The conductive material in the above range may improve the electrical conductivity without deteriorating battery performance.

The positive electrode active material layer may further include a solid electrolyte. The solid electrolyte included in the positive active material layer may be an inorganic solid electrolyte such as a sulfide solid electrolyte, an oxide solid electrolyte, a halide solid electrolyte, and the like, or a solid polymer electrolyte. The solid electrolyte may be as described above, and may be the same as or different from the solid electrolyte included in the solid electrolyte layer.

Based on a total weight of the positive electrode active material layer, the solid electrolyte may be included at an amount of about 0.1 wt % about to 35 wt %, e.g., about 1 wt % to about 35 wt %, about 5 wt % to about 30 wt %, about 8 wt % to about 25 wt %, or about 10 wt % to about 20 wt %. In the positive electrode active material layer, based on a total weight of the positive electrode active material and the solid electrolyte, the positive electrode active material may be included in an amount of about 65 wt % to about 99 wt % and the solid electrolyte may be included in an amount of about 1 wt % to about 35 wt %, e.g., the positive electrode active material may be included in an amount of about 80 wt % to about 90 wt % and the solid electrolyte may be included in an amount of about 10 wt % to about 20 wt %. If the solid electrolyte with the amount in the above range is included in the positive electrode, the efficiency and cycle-life characteristic of the all solid-state battery may be improved, without deterioration of capacity.

The positive current collector may include, e.g., indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may have a foil shape or a sheet shape.

### [Method of Preparing Positive Electrode]

A positive active material, a binder, and/or a conductive material may be added to a solvent to prepare a positive electrode composition. A solid electrolyte may be further added to the positive electrode composition. The solvent may be isobutyryl isobutyrate, xylene, toluene, benzene, hexane, or a combination thereof.

The positive electrode composition may be coated on a current collector, dried, and pressurized to prepare a positive electrode. The positive active material, the binder, the conductive material, and the solid electrolyte are as described in above. Amounts of each component may be used in order to have amounts included in the positive electrode.

### <Elastic Layer>

The all solid-state battery according to one or more embodiments may further include an elastic layer which may help buffer changes in the thickness of the electrode during charging and discharging. The elastic layer may be between the negative electrode and a case. The elastic layer may include materials having elasticity recovery rate of about 50% or more and insulating properties, and in some embodiment, may include a silicon rubber, an acryl rubber, a fluorine-included rubber, nylon, a synthetic rubber, or a combination thereof. The elastic layer may be a polymer sheet.

### <Preparation of all Solid-State Battery >

The all solid-state battery according to one or more embodiments may be fabricated by sequentially stacking the negative electrode and the positive electrode, while inserting the solid electrolyte layer between the negative electrode and the positive electrode to prepare an assembly, and pressurizing (e.g., pressing) the assembly.

The pressurization may be carried out at a temperature of about 25° C. to about 90° C. For example, the pressurization may be carried out under a pressure of about 550 MPa, e.g., about 500 MPa or about 1 MPa to about 500 MPa. The pressurization time may be varied depending on temperature and pressure, e.g., less than about 30 minutes. The pressurization may be, e.g., an isostatic press, a roll press, a plate press, or a warm isostatic press.

The all-solid-state rechargeable battery is a unit cell having a structure of positive electrode/solid electrolyte layer/negative electrode, a bicell having a structure of positive electrode/solid electrolyte layer/negative electrode/solid electrolyte layer/positive electrode, or a stacked battery in which the structure of the unit cell is repeated.

The shape of the all-solid-state rechargeable battery may be, e.g., coin-shaped, button-shaped, sheet-shaped, stacked-shaped, cylindrical, flat, or the like. The all solid-state rechargeable battery may also be applied to large batteries used in electric vehicles, or the like. In some embodiments, the all solid-state rechargeable battery may also be used in hybrid vehicles such as plug-in hybrid electric vehicles (PHEV). In some embodiments, it may be used in a field requiring a large amount of power storage, and may be used, e.g., in an electric bicycle or a power tool. The all solid-state rechargeable battery may be used in various fields such as portable electronic devices.

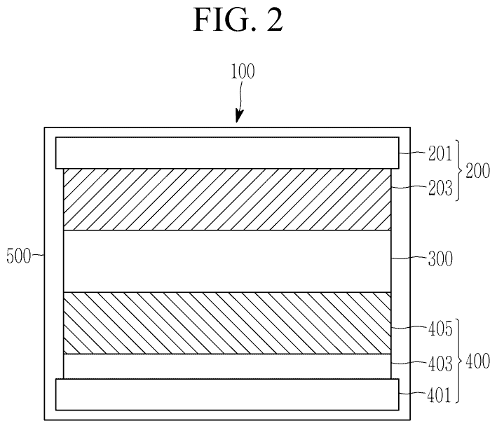

FIG. 2 is a cross-sectional view showing the all solid-state battery according to one or more embodiments. Referring to FIG. 2, an all solid-state battery 100 may have a structure in which an electrode assembly includes the negative electrode 400 having the current collector 401 (i.e., a negative current collector) and a negative active material layer (i.e., the first layer 403 and the second layer 405), a solid electrolyte layer 300, and a positive electrode 200 having a positive current collector 201 and a positive active material layer 203, which may be housed in a case, e.g., a pouch or the like. The all solid-state battery 100 may further include an elastic layer 500 on the outside of at least one of the positive electrode 200 and the negative electrode 400.

In some embodiments, the all-solid-state battery may be charged, and lithium ions may be released from the positive electrode active material and deposited on the negative electrode current collector 401, thereby preparing a lithium-containing layer (i.e., lithium deposition layer).

In some embodiments, as illustrated in FIG. 2, one electrode assembly may include the negative electrode 400, the solid electrolyte layer 300, and the positive electrode 200, or an all solid-state battery may be fabricated by stacking at least two electrode assemblies. In some embodiments, two to one hundred electrode assemblies, e.g., three to fifty or four to twenty, or the like may be stacked.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

### (1)Preparation of Negative Electrode

93 wt % of a Si-carbon composite and 7 wt % of a polyvinylidene fluoride binder were mixed in an N-methyl pyrrolidone solvent to prepare a first layer composition.

As the Si-carbon composite, an aggregate where silicon nano particles having an average particle diameter (D50) of 100 nm and soft carbon were aggregated, coated with a soft carbon coating layer, was used. An amount of the silicon nano particles was 40 wt %, based on a total weight of the silicon-carbon composite, and an amount of the soft carbon was 60 wt %, and a thickness of the soft carbon coating layer was 100 nm.

0.25 g of a mixture of carbon black with an average particle diameter (D50) of about 30 nm and silver (Ag) with an average particle diameter (D50) of about 60 nm at a weight ratio of 3:1, was added to 2g of an N-methyl pyrroldione binder solution including 7 wt % of a polyvinylidene fluoride binder, and mixed to prepare a second layer composition.

The first layer composition was coated on a nickel foil current collector using a bar coater and vacuum-dried to prepare a first layer, and then the second layer composition was coated on the first layer using a bar coater and vacuum-dried to prepare a second layer, thereby preparing a negative electrode. The first layer had a thickness of 15 μm and the second layer had a thickness of 10 μm.

### 2)Preparation of Positive Electrode

85 wt % of a LiNi_{0.8}Co_{0.15}Mn_{0.05}O₂ positive active material, 13.5 wt % of a lithium agyrodite-type solid electrolyte Li₆PS₅Cl, 1.0 wt % of a polyvinylidene fluoride binder, and 0.5 wt % of a carbon nanotubes conductive material were mixed in a xylene solvent to prepare a positive electrode composition. The prepared positive electrode composition was coated on an aluminum foil current collector using a bar coater, dried, and pressurized to prepare a positive electrode.

### 3)Preparation of Solid Electrolyte Layer

To an agyrodite-type solid electrolyte Li₆PS₅Cl, a binder solution in which butyl acrylate as an acrylate polymer was added to isobutylyl isobutylate binder solution (solid amount: 50 wt %) was added and then mixed. A mixing ratio of the solid electrolyte and the binder was a weight ratio of 98.7:1.3.

The mixing process was carried out using a Thinky mixer. The mixture was added with a 2 mm zirconia ball and was repeatedly agitated using the Thinky mixer to prepare a slurry. The slurry was cast on a release polytetrafluoroethylene film and dried at a room temperature to prepare a solid electrolyte layer with a thickness of 100 μm.

### 4) Fabrication of all Solid-State Cell

The prepared negative electrode, the solid electrolyte layer, and the positive electrode were sequentially stacked, and the pressure was applied at an isostaic pressure of 380 MPa to fabricate an all solid-state cell. In the fabricated battery, the N/P ratio was 0.5.

### Example 2

An all solid-state cell with a N/P ratio of 1 was fabricated by the same procedure as in Example 1, except that the thickness of the first layer was changed into 30 μm and the thickness of the second layer was changed into 10 μm.

### Comparative Example 1

An all solid-state cell was fabricated by the same procedure as in Example 1, except that the thickness of the first layer was changed into 0 μm (i.e., the first layer was not formed) and the thickness of the second layer was changed into 10 μm. The fabricated battery could not be defined by the N/P ratio.

### Comparative Example 2

An all solid-state cell with a N/P ratio of 1 was fabricated by the same procedure as in Example 1, except that the thickness of the first layer was changed into 30 μm and the thickness of the second layer was changed into 0 μm (i.e., the second layer was not formed).

### Comparative Example 3

An all solid-state cell with a N/P ratio of 1.5 was fabricated by the same procedure as in Example 1, except that the thickness of the first layer was changed into 45 μm and the thickness of the second layer was changed into 0 μm (i.e., the second layer was not formed).

### Comparative Example 4

An all solid-state cell with a N/P ratio of 2.5 was fabricated by the same procedure as in Example 1, except that the thickness of the first layer was changed into 75 μm and the thickness of the second layer was changed into 10 μm.

The N/P ratio of the all solid-state cells according to Examples 1 to 2 and Comparative Examples 1 to 4 are summarized in Table 1, below. The all solid-state cell of Comparative Example 1 was the cell which could not be defined by the N/P ratio, and thus, the N/P ratio was represented as “.

### Experimental Example 1: Evaluation of Capacity Retention

The all solid-state cells according to Examples 1 and 2, and Comparative Examples 1 to 3 were charged and discharged at 0.1 C at 45° C. for 160 cycles. A ratio of discharge capacity at a 160^{th} cycle relative to discharge capacity at a 1^{st} cycle was calculated.

The all solid-state cell of Comparative Example 3 exhibited a surprisingly deteriorated cycle-life when the cell was charged and discharged at 0.1 C at 45° C. for 70 cycles, and thus, the charge and discharge were stopped at the 70^{th} cycle. Thus, in Comparative Example 3, a ratio of discharge capacity at the 70^{th} cycle relative to discharge capacity at the 1^{st} cycle was calculated.

The all solid-state cell of Comparative Example 4 was charged and discharged at 0.1 C at 45° C., but the discharge capacity was decreased to almost 0 after charging and discharging twice. Thus, no subsequent experiments were performed and the capacity retention of Comparative Example 4 in Table 1 is represented as”--“

The results are show in Table 1, below, as capacity retention.

TABLE 1

| | | | Capacity |
|---|---|---|---|
| | | N/P | retention |
| | First layer thickness:second layer thickness | ratio | (%) |
| Example 1 | 15:10 | 0.5 | 75.62 |
| Example 2 | 30:10 | 1 | 63.12 |
| Comparative | 0:10 | — | 57.96 |
| Example 1 | | | |
| Comparative | 30:0 | 1 | 53.90 |
| Example 2 | | | |
| Comparative | 45:0 | 1.5 | 36.5 |
| Example 3 | | | |
| Comparative | 75:10 | 2.5 | — |
| Example 4 | | | |

As shown in Table 1, Examples 1 and 2 exhibited superior capacity retention compared to Comparative Example 1 to 2. Comparative Example 3 exhibited abruptly deteriorated capacity retention of 36.5% at 70^{th} cycle, and Comparative Example 4 exhibited no capacity retention.

By way of summation and review, one or more embodiments provide a negative electrode for an all solid-state battery that includes a Si-carbon composite, thereby exhibiting excellent safety and high energy density. Another embodiment provides an all solid-state battery including the negative electrode.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A negative electrode for an all solid-state battery, the negative electrode comprising:
a current collector;
a first layer on the current collector, the first layer including a Si-carbon composite; and
a second layer on the first layer, the second layer including a carbonaceous material and a metal,
wherein a ratio of a capacity of the negative electrode/a capacity of a positive electrode is about 0.5 to about 2.

2. The negative electrode for an all solid-state battery as claimed in claim 1, wherein a ratio of a thickness of the first layer to a thickness of the second layer is about 1.5:1 to about 6:1.

3. The negative electrode for an all solid-state battery as claimed in claim 1, wherein a ratio of a thickness of the first layer to a thickness of the second layer is about 1.5:1 to about 4.5:1.

4. The negative electrode for an all solid-state battery as claimed in claim 1, wherein the first layer has a thickness of about 5 μm to about 100 μm.

5. The negative electrode for an all solid-state battery as claimed in claim 1, wherein the second layer has a thickness of about 1 μm to about 50 μm.

6. The negative electrode for an all solid-state battery as claimed in claim 1, wherein the Si-carbon composite comprises silicon nano particles and amorphous carbon.

7. The negative electrode for an all solid-state battery as claimed in claim 1, wherein the Si-carbon composite comprises:
a secondary particle, the secondary particle comprising aggregated silicon primary particles; and
an amorphous carbon on surfaces of the primary particles and the secondary particle.

8. The negative electrode for an all solid-state battery as claimed in claim 6, wherein the Si-carbon composite further comprises crystalline carbon.

9. The negative electrode for an all solid-state battery as claimed in claim 1, wherein the carbonaceous material comprises crystalline carbon, amorphous carbon, or a combination thereof.

10. The negative electrode for an all solid-state battery as claimed in claim 1, wherein the carbonaceous material comprises amorphous carbon.

11. The negative electrode for an all solid-state battery as claimed in claim 10, wherein the amorphous carbon comprises carbon black, acetylene black, denka black, Ketjen black, furnace black, activated carbon, graphene, or a combination thereof.

12. The negative electrode for an all solid-state battery as claimed in claim 1, wherein the metal comprises Ag, Au, Sn, Zn, Al, Mg, Ge, Cu, In, Ni, Bi, Pt, Pd, or a combination thereof.

13. The negative electrode for an all solid-state battery as claimed in claim 1, wherein the metal comprises Ag.

14. An all solid-state battery, comprising:
the negative electrode of claim 1;
the positive electrode; and
a solid electrolyte layer between the negative electrode and the positive electrode.
